(19) United States
(12) Patent Application Publication
(10) Pub. No.: US 2026/0296590 A1
(43) Pub. Date: Oct. 1, 2026

(54) ACCELERATOR ASSEMBLY FOR AN OFF-ROAD VEHICLE

(71) Applicant: BOMBARDIER RECREATIONAL PRODUCTS INC., Valcourt (CA)

(72) Inventor: Benoit SIMARD, Bromont (CA)

(21) Appl. No.: 19/629,466

(22) Filed: Mar. 26, 2026

Related U.S. Application Data
(60) Provisional application No. 63/779,645, filed on Mar. 28, 2025.

(51) Int. Cl. B62K 23/04; B60L 7/10; B62J 43/16; B62J 45/413; B62L 5/00; G01D 5/14

(52) U.S. Cl. CPC B62K 23/04; B60L 7/10; B62J 43/16; B62J 45/413; B62L 5/006; G01D 5/145; B62K 2204/00

(57) ABSTRACT

An accelerator assembly for a vehicle and a vehicle. The accelerator assembly includes a target member; a sensor configured to sense an interaction of the target member with the sensor; a target member actuator operatively connected to the target member and configured to cause movement of the target member relative to the sensor; and a sensor actuator operatively connected to the sensor and configured to cause movement of the sensor relative to the target member. A vehicle having the accelerator assembly is also disclosed.

### CROSS-REFERENCE

The present application claims priority to U.S. Provisional Patent Application No.: 63/779,645, filed Mar. 28, 2025, which is incorporated herein by reference in its entirety.

### TECHNICAL FIELD

The present technology relates to off-road vehicles and an accelerator assembly for off-road vehicles.

### BACKGROUND

Off-road vehicles, such as all-terrain vehicles (ATVs), are frequently operated on rough and uneven terrain. In many situations, drivers must dynamically shift their body weight—such as by standing or leaning—to maintain stability and control.

To integrate regenerative braking into electric off-road vehicles, bidirectional twist grip accelerators have been used, allowing acceleration when rotated in one direction and regenerative braking when rotated in the opposite direction. However, the uneven terrain and the driver's shifting body weight can lead to unintended inputs, potentially causing unintentional acceleration or unintentional activation of regenerative braking, which may negatively impact the vehicle's operation.

In view of the foregoing, there is a need for an accelerator assembly that addresses at least some of these drawbacks.

### SUMMARY

It is an object of the present technology to ameliorate at least some of the inconveniences present in the prior art.

In one aspect of the present technology, an accelerator assembly for a vehicle is provided. The accelerator assembly including: a target member; a sensor configured to sense an interaction of the target member with the sensor; a target member actuator operatively connected to the target member and configured to cause movement of the target member relative to the sensor; and a sensor actuator operatively connected to the sensor and configured to cause movement of the sensor relative to the target member.

In some embodiments, actuation of the target member actuator causes rotation of the target member about a target member axis; and actuation of the sensor actuator causes rotation of the sensor about a sensor axis.

In some embodiments, the target member axis and the sensor axis are coaxial.

In some embodiments, actuation of the target member actuator causes movement of the target member in the same direction as actuation of the sensor actuator causes movement of the sensor.

In some embodiments, the sensor is a non-contact sensor.

In some embodiments, the target member is a magnet; and the sensor is a magnetic field sensor.

In some embodiments, the magnetic field sensor is a Hall-effect sensor.

In some embodiments, the target member actuator is a twist grip of a handlebar of the vehicle.

In some embodiments, the accelerator assembly further includes a controller communicatively connected to the sensor, the controller being configured to engage a motor braking mode of the vehicle based on the sensed interaction of the target member with the sensor.

In some embodiments, is an electric vehicle having a battery, the controller being communicatively connected to the battery, and the motor braking mode is a regenerative braking mode.

In some embodiments, the accelerator assembly further includes a sensor actuator biasing member for biasing the sensor actuator towards an unactuated sensor actuator position; and a sensor biasing member for biasing a position of the sensor towards an unactuated sensor position.

In another broad aspect of the present technology, a vehicle is provided. The vehicle has a motor; an accelerator assembly having: a target member; a sensor configured to sense an interaction of the target member with the sensor; a target member actuator operatively connected to the target member, the target member actuator being configured to cause movement of the target member relative to the sensor; and a sensor actuator operatively connected to the sensor, the sensor actuator being configured to cause movement of the sensor relative to the target member; and a controller communicatively connected to the motor and the sensor, the controller being configured to: receive a signal from the sensor indicative of the sensed interaction of the target member with the sensor; and controlling the motor to initiate a motor braking mode based on the sensed interaction.

In some embodiments, the vehicle further includes a handlebar, the target member actuator is a twist grip of the handlebar; and the sensor actuator is a button disposed on the handlebar.

In some embodiments, actuation of the target member actuator causes rotation of the target member about a target member axis; and actuation of the sensor actuator causes rotation of the sensor about a sensor axis.

In some embodiments, the target member axis and the sensor axis are coaxial.

In some embodiments, actuation of the target member actuator causes movement of the target member in the same direction as actuation of the sensor actuator causes movement of the sensor.

In some embodiments, the sensor is a non-contact sensor.

In some embodiments, the target member is a magnet; and the sensor is a magnetic field sensor.

In some embodiments, the magnetic field sensor is a Hall-effect sensor.

In some embodiments, the vehicle is an electric vehicle having a battery, the controller being communicatively connected to the battery, and the motor braking mode is a regenerative braking mode.

In some embodiments, the vehicle further includes a sensor actuator biasing member for biasing the sensor actuator towards an unactuated sensor actuator position; and a sensor biasing member for biasing a position of the sensor towards an unactuated sensor position.

For purposes of the present application, terms related to spatial orientation when referring to a vehicle and components in relation to the vehicle, such as “forwardly”, “rearwardly”, “left”, “right”, “above” and “below”, are as they would be understood by a driver of the vehicle sitting thereon in an upright driving position, with the vehicle steered straight-ahead.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a right side elevation view of an off-road vehicle;

FIG. 2 depicts a perspective view taken from a front, left side of an accelerator assembly of the off-road vehicle of FIG. 1 with a portion of a housing removed and a button of the accelerator assembly in an unactuated position;

FIG. 3 depicts a perspective view taken from a front, left side of the accelerator assembly of FIG. 2 with the button of the accelerator assembly in the unactuated position;

FIG. 4 depicts a perspective view taken from a front, left side of the accelerator assembly of FIG. 2 with the button of the accelerator assembly in the actuated position;

FIG. 5 depicts an exploded, perspective view taken from a front, right side of the accelerator assembly of FIG. 2;

FIG. 6 depicts a front elevation view of a housing of the accelerator assembly;

FIG. 7 depicts a cross-sectional view of the housing of FIG. 6 taken along line A-A of FIG. 6 with a target element and a sensor rotated;

FIG. 8 depicts a cross-sectional view of the housing of FIG. 6 taken along line A-A of FIG. 6 with the sensor in a neutral position and the target element rotated; and

FIG. 9 depicts a cross-sectional view of the housing of FIG. 6 taken along line A-A of FIG. 6 with the target element in a neutral position and the sensor rotated.

### DETAILED DESCRIPTION

The present technology will be described with reference to a four-wheeled all-terrain vehicle (ATV) 10. However, it is contemplated that aspects of the present technology could be used in other types of vehicles, such as three-wheeled vehicles.

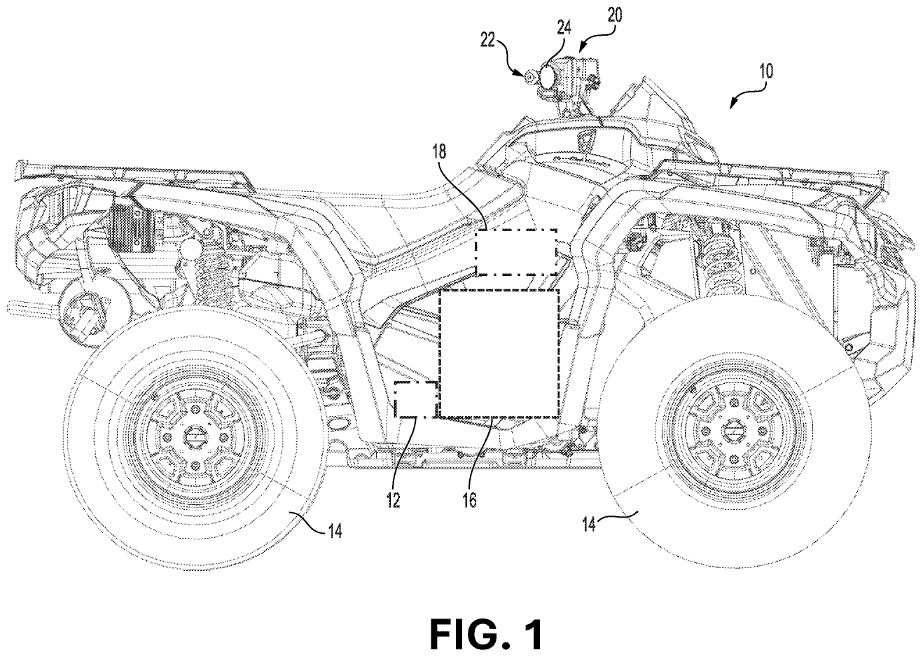

As depicted in FIG. 1, the ATV 10 includes a motor 12. In the present embodiment, the motor 12 is an electric motor 12 (schematically shown), referred to hereinafter as the motor 12, configured to power the ATV 10. It is contemplated that, in alternative embodiments, the motor 12 may be an internal combustion engine. The ATV 10 has two front wheels 14 (only a right front wheel 14 is depicted) and two rear wheels 14 (only a right rear wheel 14 is depicted). The wheels 14 are operatively connected to the motor 12 via a transmission (not depicted). The ATV 10 includes a battery 16 (schematically shown) electrically connected to the motor 12, serving as a power source for the motor 12.

The ATV 10 further includes a controller 18 (schematically shown) communicatively connected to the motor 12 and the battery 16. The controller 18 is configured to regulate power delivery from the battery 16 to the motor 12 during propulsion of the ATV 10. The controller 18 is configured to control the motor 12 to initiate a motor braking mode. In the present embodiment, the motor braking mode is a regenerative braking mode in which the motor 12 acts as a generator and supplies energy to the battery 16. In embodiments where the motor 12 is an internal combustion engine, the motor braking mode in an engine braking mode in which the vehicle slows down as a result of the retarding forces in the motor 12. It is contemplated that in embodiments where the motor 12 is an internal combustion engine, the controller 18 could additionally be configured to cause a down-shift of the transmission of the ATV 10 when the motor braking mode is engaged.

The ATV 10 further includes a steering assembly 20 to enable a driver to steer the ATV 10. The steering assembly 20 includes a handlebar 22 operatively connected to the front wheels 14 of the ATV 10. The handlebar 22 includes an accelerator assembly 24 (schematically shown in FIG. 1) mounted to the handlebar 22. The accelerator assembly 24 is communicatively connected to the controller 18 to facilitate acceleration and initiate regenerative braking mode.

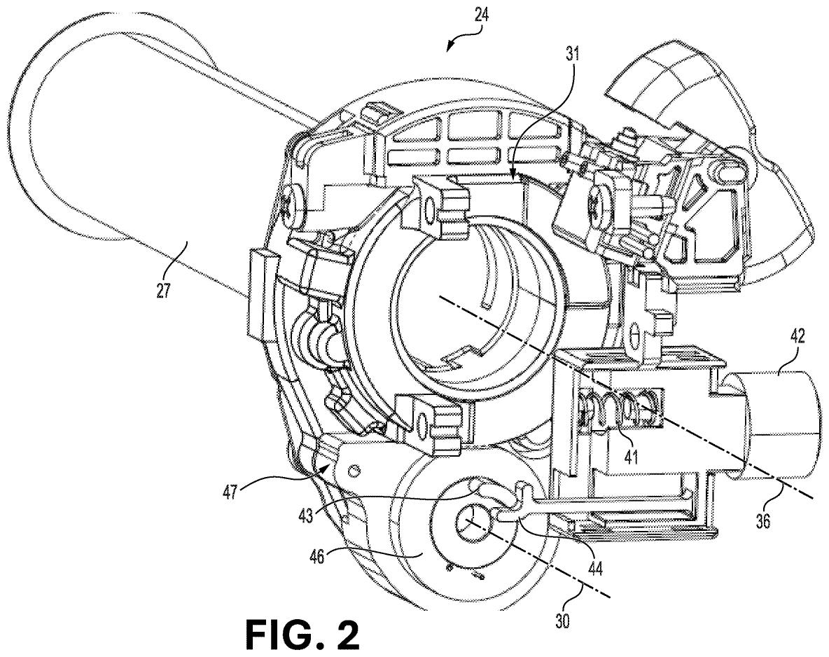

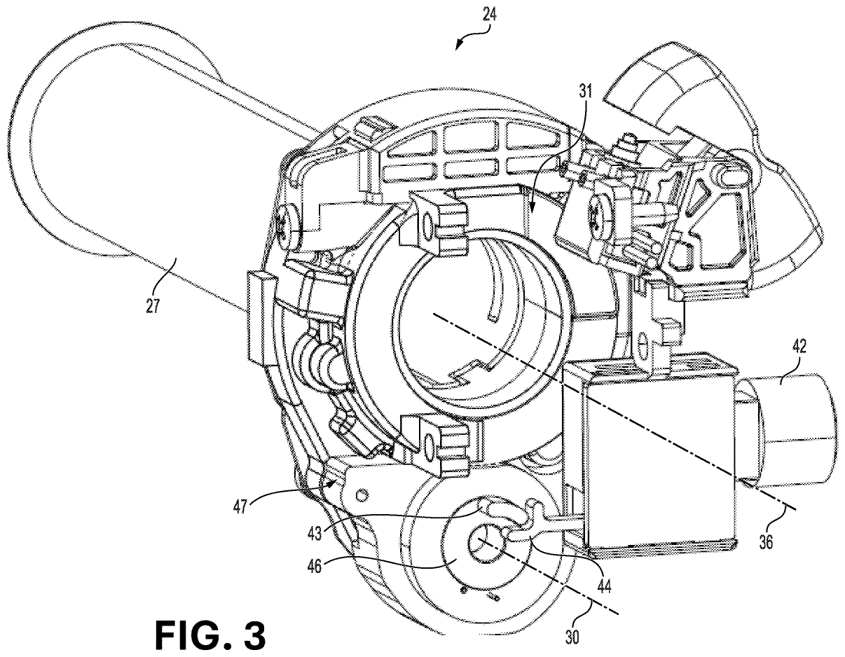

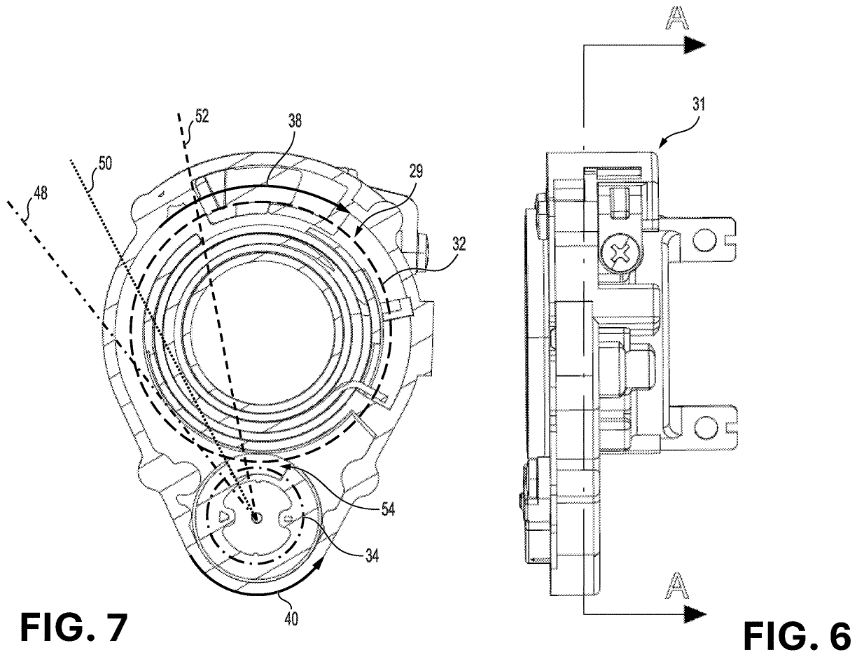

With reference to FIGS. 2 to 7, the accelerator assembly 24 will be described in detail. The accelerator assembly 24 includes a twist grip 27 which is configured to operate acceleration of the ATV 10. The twist grip 27 is rotationally coupled to the handlebar 22. As described below, rotating the twist grip 27 in a first direction causes the motor 12 to apply torque to the wheels 14, resulting in the acceleration of the ATV 10.

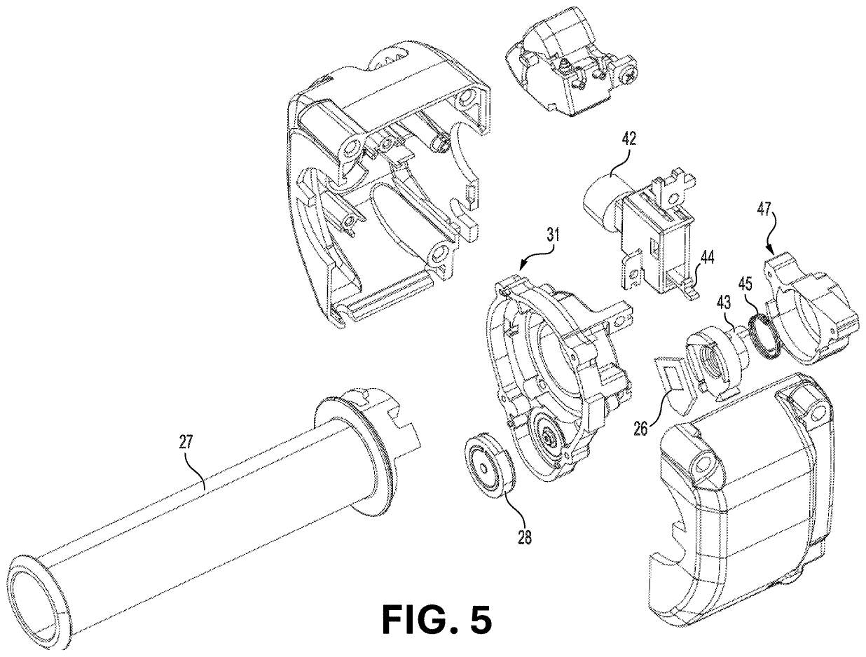

In the present embodiment, the accelerator assembly 24 includes a sensor 26, such as a magnetic field sensor 26 (FIG. 5), and a target member, such as a magnet 28 (FIG. 5), which is sensed by the magnetic field sensor 26 as described below. In the present embodiment, the magnetic field sensor 26 is a Hall-effect sensor 26. The Hall-effect sensor 26 is configured to sense a change in the magnetic field of the magnet 28 based on the relative position between the Hall-sensor 26 and the magnet 28. The Hall-effect sensor 26 is communicatively connected to the controller 18. The Hall-effect sensor 26 is configured to transmit a signal indicative of a change in the detected magnetic field to the controller 18. In response to the signal, the controller 18 controls the motor 12. It is contemplated that, in some embodiments, the magnetic field sensor 26 may be a magnetoresistive sensor. In other embodiments, the accelerator assembly 24 may implement any two-part sensor having a target member and a sensor for sensing an interaction of the target member and the sensor. For example, in alternative embodiments, the accelerator assembly 24 may implement an inductive sensor and a conductive metal or a potentiometer and a moveable component.

The twist grip 27 is operatively connected to the magnet 28. The twist grip 27 functions as a magnet 28 actuator, such that rotation of the twist grip 27 causes the magnet 28 to rotate about a rotation axis 30. In the present embodiment, the twist grip 27 is operatively connected to the magnet 28 via a friction wheel assembly 29 which consists of a first wheel 32 and a second wheel 34 (schematically shown in FIG. 7) engaged with one another at contact point 54. The first wheel 32 is operatively connected to and driven by the twist grip 27. In the present embodiment, the first wheel 32 and the twist grip 27 are coaxial, rotating about a rotation axis 36. Rotation of the twist grip 27 causes a corresponding rotation of the first wheel 32 in the same direction as the twist grip 27. For example, rotation of the twist grip 27 in the first direction (denoted by arrow 38 in FIG. 7) causes a corresponding rotation of the first wheel 32 in the first direction. The second wheel 34 is operatively connected to and driven by the first wheel 32. Rotation of the first wheel 32 in causes a corresponding rotation of the second wheel 34 in an opposite direction to that of the first wheel 32. For example, rotation of the first wheel in the first direction causes a corresponding rotation of the second wheel 34 in a second, opposite, direction (denoted by arrow 40 in FIG. 7). In alternative embodiments, the wheel assembly 29 may be a gear assembly.

The magnet 28 is operatively connected to the second wheel 34 such that the magnet 28 rotates with the second wheel 34. In the present embodiment, the magnet 28 and the second wheel 34 are coaxial, rotating about the rotation axis 30. Rotation of the second wheel 34 causes a corresponding rotation of the magnet 28 in the same direction as the second wheel 34. The magnet 28 is configured to move independently relative to the Hall-effect sensor 26. The Hall-effect sensor 26 is positioned coaxial with the magnet 28. As the twist grip 27 rotates, the magnet 28 correspondingly rotates relative to the Hall-effect sensor 26, causing a change in the magnetic field detected by the Hall-effect sensor 26.

In this embodiment, the first wheel 32, the second wheel 34, and the magnet 28 are housed within a housing 31. The housing 31 is formed as a unitary piece, however this may vary in various embodiments. In alternative embodiments, the housing 31 may be omitted.

The accelerator assembly 24 further includes a regenerative braking button 42, referred to hereinafter as the button 42. The button 42 is configured to engage and modulate regenerative braking of the ATV 10. The button 42 is disposed on the handlebar 22. In the present embodiment, the button 42 is disposed on the same side of the handlebar 22 as the twist grip 27. It is contemplated, in alternative embodiments, the button 42 may be positioned elsewhere on the handlebar 22 or the ATV 10.

The button 42 is operatively connected to the Hall-effect sensor 26. The button 42 functions as a Hall-effect sensor 26 actuator, such that actuation of the button 42 causes movement of the Hall-effect sensor 26. The Hall-effect sensor 26 is configured to move independently relative to the magnet 28. Referring to FIG. 2, the button 42 is operatively connected to an arm 44, which is engaged with a disc 46 that supports the Hall-effect sensor 26. In this embodiment, the disc 46 includes a protrusion 43 which is engaged with the arm 44.

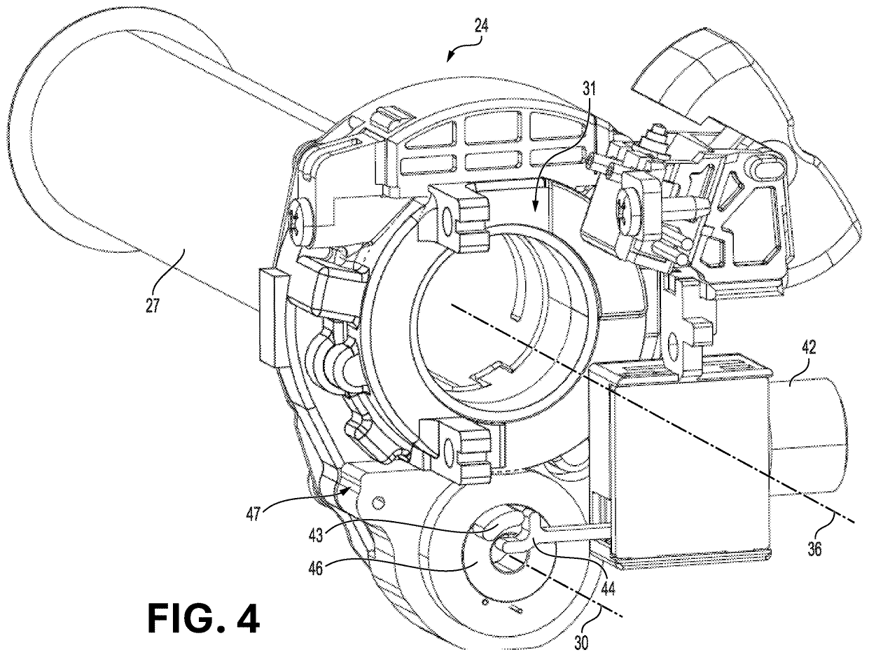

As depicted in FIG. 4, pressing the button 42 moves the arm 44 which in turn rotates the disc 46, thereby causing the Hall-effect sensor 26 to rotate about the rotation axis 30. Specifically, in the present embodiment, the Hall-effect sensor 26 is rotates in the same direction as the magnet 28 (i.e., the second direction denoted by arrow 40 in FIG. 7). Releasing the button 42 moves the arm 44 which causes the Hall-effect sensor 26 to rotate about the rotation axis 30 back to a neutral position (i.e., opposite to the second direction). It is noted that the button 42 and the arm 44 may be replaced by any other suitable actuation mechanism. For example, in alternative embodiments, a lever and a pull-cable may be implemented. In this alternative configuration, the lever is operatively connected to the disc 46—and consequently the Hall-effect sensor 26—via the pull-cable.

In this embodiment, the Hall-effect sensor 26 and the disc 46 are partially housed within a housing 47. Specifically, the protrusion 43 is exposed to allow engagement with the arm 44. It is contemplated that, in alternative embodiments, the housing 47 may be omitted.

The accelerator assembly 24 includes a button biasing member 41 configured to bias the button 42 towards an unactuated position. In the present embodiment, the button biasing member 41 is a spring 41. It is contemplated that other suitable biasing members may be implemented in other embodiments. In alternative embodiments, the button biasing member 41 may be omitted.

The accelerator assembly 24 includes a sensor biasing member 45 (FIG. 5) configured to bias the Hall-effect sensor 26 towards an unactuated position. In the present embodiment, the sensor biasing member 45 is a circular spring 45. The circular spring 45 is inserted between the disc 46 and the housing 47. It is contemplated that other suitable biasing members may be implemented in other embodiments. In alternative embodiments, the sensor biasing member 45 may be omitted.

Operation of the ATV 10 during normal operation and regenerative braking mode will now be described. It is noted that the terms “positive” angle, “negative” angle, and “zero” are used solely for explanatory clarity and are not intended to limit the scope of the present technology.

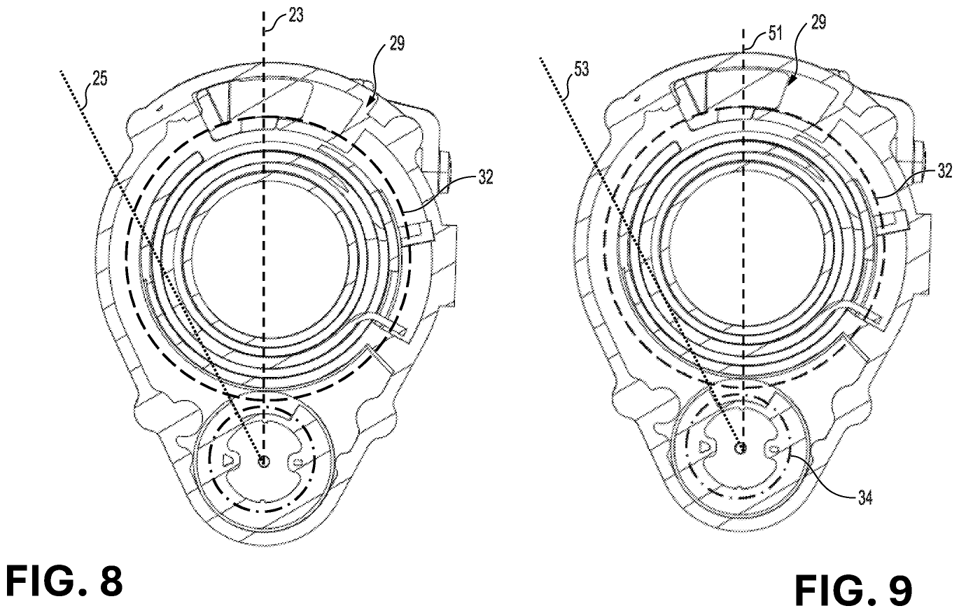

During normal operation, when the button 42 is unactuated, the driver accelerates the ATV 10 by rotating the twist grip 27. This rotation causes the magnet 28 to rotate about the rotation axis 30 while the Hall-effect sensor 26 is in an unactuated position (denoted by dashed line 23 in FIG. 8). As a result, rotation of the magnet 28 (denoted by dashed line 25 in FIG. 8) rotates its magnetic field relative to the Hall-effect sensor 26. This increases the relative angular position between them, resulting in a “positive” relative angular position. As the magnet 28 moves, the Hall-effect sensor 26 detects a corresponding change in the magnetic field. The Hall-effect sensor 26 outputs a signal indicative of the change in the magnetic field and transmits it to the controller 18. In response, the controller 18 signals the motor 12 to apply torque to the wheels 14 based on the received signal. The amount of torque applied to the wheels 14 is determined by the relative angular position between the Hall-effect sensor 26 and the magnet 28. For example, the greater the relative angular position, the higher the torque output, leading to acceleration of the ATV 10. Upon release of the twist grip 27, the ATV 10 will initiate the regenerative braking mode in which the motor 12 acts as a generator and supplies energy to the battery 16. It is contemplated that releasing the throttle may be configured to cause the ATV 10 to freely coast, without applying any regenerative braking.

When the driver activates the regenerative braking mode by pressing the button 42, the amount of regenerative braking can be increased relative to the normal amount of regenerative braking, such as the amount of regenerative braking experienced when the throttle is released and the button 42 is not being pressed. When the driver presses the button 42, the Hall-effect sensor 26 is rotated about the rotation axis 30 while the magnet 28 is in an unactuated position (denoted by dashed line 51 in FIG. 9). As a result, rotation of the Hall-effect sensor 26 (denoted by dashed line 53 in FIG. 9) causes relative rotation of the magnetic field of the magnet 28. This increases the relative angular position between them, resulting in a “negative” relative angular position. As the Hall-effect sensor 26 moves, the Hall-effect sensor 26 detects a corresponding change in the magnetic field position. The Hall-effect sensor 26 outputs a signal corresponding to the change in magnetic field and transmits it to the controller 18. In response, the controller 18 signals the motor 12 to initiate the regenerative braking mode in which the motor 12 acts as a generator and supplies energy to the battery 16.

In certain situations, the driver may be accelerating the ATV 10 and actuate the button 42. In other words, the magnet 28 is rotated due to rotation of the twist grip 27 and the Hall-effect sensor 26 is rotated, in the same direction as the magnet 28, due to actuation of the button 42.

Referring to FIG. 7, if the rotation of the Hall-effect sensor 26 (denoted by dashed line 48) is greater than the rotation of the magnet 28 (denoted by dashed line 50), the relative angular position would be “negative”. As the Hall-effect sensor 26 moves, the Hall-effect sensor 26 detects a corresponding change in the magnetic field. The Hall-effect sensor 26 outputs a signal corresponding to the change in magnetic field position and transmits it to the controller 18. In response, the controller 18 signals the motor 12 to initiate the regenerative braking mode in which the motor 12 supplies energy to the battery 16.

If the rotation of the Hall-effect sensor 26 (denoted by the dashed line 52) is less than the rotation of the magnet 28 (denoted by dashed line 50), the relative angular position would be “positive”. In response, the controller 18 signals motor 12 to apply torque to the wheels 14. In this instance, the relative angular position between the magnet 28 and the Hall-effect sensor 26 would decrease, leading to a decrease in the applied torque to the wheels 14, causing the driver to feel a reduced acceleration of the ATV 10.

In the instance where, the rotation of the Hall-effect sensor 26 is equal to the rotation of the magnet 28 such that the relative angular position between them is “zero”, the controller 18 is configured to signal the motor 12 to initiate the regenerative braking mode, with a braking torque less than that which is possible when the relative angular position between the magnet 28 and Hall effect sensor 26 is “negative”. It is contemplated that, in alternative embodiments, the controller 18 may be configured to cause the ATV 10 to coast.

The disclosed embodiments of the accelerator assembly 24 allows the driver of the ATV 10 to activate regenerative braking independently of the twist grip 27, using a separate actuator. Specifically, acceleration is controlled via the twist grip 27, while regenerative braking is engaged using the button 42. This configuration enables the driver to initiate regenerative braking without needing to adjust the position of the twist grip 27. Likewise, upon releasing the button 42, acceleration can seamlessly resume, as the position of the twist grip 27 remained unchanged.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. An accelerator assembly for a vehicle, the accelerator assembly comprising:
a target member;
a sensor configured to sense an interaction of the target member with the sensor;
a target member actuator operatively connected to the target member and configured to cause movement of the target member relative to the sensor; and
a sensor actuator operatively connected to the sensor and configured to cause movement of the sensor relative to the target member.

2. The accelerator assembly of claim 1, wherein:
actuation of the target member actuator causes rotation of the target member about a target member axis; and
actuation of the sensor actuator causes rotation of the sensor about a sensor axis.

3. The accelerator assembly of claim 2, wherein the target member axis and the sensor axis are coaxial.

4. The accelerator assembly of claim 1, wherein:
actuation of the target member actuator causes movement of the target member in the same direction as actuation of the sensor actuator causes movement of the sensor.

5. The accelerator assembly of claim 1, wherein the sensor is a non-contact sensor.

6. The accelerator assembly of claim 1, wherein:
the target member is a magnet; and
the sensor is a magnetic field sensor.

7. The accelerator assembly of claim 1, wherein the target member actuator is a twist grip of a handlebar of the vehicle.

8. The accelerator assembly of claim 1, further comprising a controller communicatively connected to the sensor, the controller being configured to engage a motor braking mode of the vehicle based on the sensed interaction of the target member with the sensor.

9. The accelerator assembly of claim 8, wherein:
the vehicle is an electric vehicle having a battery;
the controller being communicatively connected to the battery; and
the motor braking mode is a regenerative braking mode.

10. The accelerator assembly of claim 1, further comprising:
a sensor actuator biasing member for biasing the sensor actuator towards an unactuated sensor actuator position; and
a sensor biasing member for biasing a position of the sensor towards an unactuated sensor position.

11. A vehicle comprising:
a motor;
an accelerator assembly having:
a target member;
a sensor configured to sense an interaction of the target member with the sensor;
a target member actuator operatively connected to the target member, the target member actuator being configured to cause movement of the target member relative to the sensor; and
a sensor actuator operatively connected to the sensor, the sensor actuator being configured to cause movement of the sensor relative to the target member; and
a controller communicatively connected to the motor, and the sensor,
the controller being configured to:
receive a signal from the sensor indicative of the sensed interaction of the target member with the sensor; and
controlling the motor to initiate a motor braking mode based on the sensed interaction.

12. The vehicle of claim 11, further comprising:
a handlebar; and
wherein:
the target member actuator is a twist grip of the handlebar; and
the sensor actuator is a button disposed on the handlebar.

13. The vehicle of claim 11, wherein:
actuation of the target member actuator causes rotation of the target member about a target member axis; and
actuation of the sensor actuator causes rotation of the sensor about a sensor axis.

14. The vehicle of claim 13, wherein the target member axis and the sensor axis are coaxial.

15. The vehicle of claim 11, wherein:
actuation of the target member actuator causes movement of the target member in the same direction as actuation of the sensor actuator causes movement of the sensor.

16. The vehicle of claim 11, wherein the sensor is a non-contact sensor.

17. The vehicle of claim 11, wherein:
the target member is a magnet; and
the sensor is a magnetic field sensor.

18. The vehicle of claim 17, wherein the magnetic field sensor is a Hall-effect sensor.

19. The vehicle of claim 11, wherein:
the vehicle is an electric vehicle having a battery;
the controller being communicatively connected to the battery; and
the motor braking mode is a regenerative braking mode.

20. The vehicle of claim 11, further comprising:
a sensor actuator biasing member for biasing the sensor actuator towards an unactuated sensor actuator position; and
a sensor biasing member for biasing a position of the sensor towards an unactuated sensor position.
